(19) United States
(12) Patent Application Publication
(10) Pub. No.: US 2001/0031051 A1
(43) Pub. Date: Oct. 18, 2001

(54) Stereo to enhanced spatialisation in stereo sound HI-FI decoding process method and apparatus

(76) Inventor: Martin Pineau, Verdun (CA)

Correspondence Address: Michael B. Lasky, Altera Law Group, LLC, Suite 100, 6500 City West Parkway, Minneapolis, MN, 55344-7701, US

(21) Appl. No.: 09/747,302

(22) Filed: Dec. 22, 2000

Related U.S. Application Data
(60) Provisional application No. 60/171,655, filed on Dec. 27, 1999.

(51) Int. Cl. H04R 5/00

(52) U.S. Cl. 381/22; 381/1; 381/17; 381/18

(57) ABSTRACT

The invention concerns an apparatus for decoding an enhanced stereo sound effect from a stereo signal. The apparatus has an input for receiving a stereo signal including localisation cues, the stereo signal comprising a left channel and a right channel, each of the left and right channels being carried over a pair of wires including a positive lead and a negative lead. The positive leads of the right and left channels are outputted directly. A decoding circuit for decoding the localisation cues from the stereo signal is placed on the negative leads of the right and left channels. The apparatus of the present invention does not require an independent power source and uses the information contained in the original signal to produce and enhanced signal.

### FIELD OF THE TECHNOLOGY

The present invention relates to the reproduction of enhanced stereo sound, and is more particularly directed to an improved alternative method and apparatus enabling the enhanced stereo sound effect to be decoded from a stereophonic signal after regular stereophonic amplification, increasing the compatibility with the end user's amplification sound system. One of the goals of the invention is to produce a spatialized 3D sound output from a set of loudspeakers, in a post amplification process.

### BACKGROUND OF THE INVENTION

For a long time, some people committed to sonic realism have been attempting to find ways to improve the performance of sound reproducing systems. This has been attempted at the recording and microphone stage (Ambisonic microphones and HRTF binaural recording heads are good examples), the pre-amp stage (Dolby's Pro-Logic™ and Bob Carver's Holographic System™ are good examples), the post-amp stage (Chase's surround processor and TARA Labs' Space and Time™ speaker cables are good examples) as well as at the reproducing stage (dbx™ and Polk Audio SDA Series™ loudspeakers are a good example).

Some of the above mentioned technologies are optimization products (Oust as ‘spikes’ are ‘tweaks’) and some others heavily modify the signals that are to be reproduced. However, there is a need for a system and method which improves the performance of a sound reproducing system, without modifying the signal to be reproduced.

Basically speaking, humans perceive and interpret sound from relative amplitude level and timing difference cues. As a matter of fact, to be more specific, there are two basic forms of cues; Timing difference—called interaural timing difference (ITD) and also Level difference—called interaural level difference (ILD).

This information can be classified as fundamental cues and localization cues. Fundamental cues range from 0-100 Hz, while localization cues are situated above 100 Hz (see FIG. 1). In listening to a live concert, various instruments are perceived that all have their own diffusion patterns. What is heard is a complex mixture of direct and reflected fundamentals and harmonics (which are most important in above 100 Hz range localization cues).

A quick definition of “stereo” given on ‘Encyclopedia.com’ follows: “Stereophonic sound—sound recorded simultaneously by two or more MICROPHONES placed in different positions relative to the sound source. The recorded sound is played back through LOUDSPEAKERS placed more or less as the recording microphones were placed. The voices or instruments composing the sound thus seem to be spread out as they would be naturally in the recording hall. Quadrophonic reproduction utilized four microphones and four loudspeakers to further enhance the effect, but it was not commercially successful. Surround Sound uses special encoding and processing to enhance the effect and also requires additional loudspeakers. It is used in movie theaters and more expensive home entertainment systems. A schematic representation of basic stereo sound is illustrated in FIG. 2.

Most experts in audio will concur that for loudspeakers to offer a sonically convincing performance, they must not attract attention to themselves. This characteristic is often referred to as ‘transparency’. The more ‘transparent’ the loudspeaker, the better the sound. The problem with most loudspeakers is that they are multi-voice. Very few loudspeakers on the market are actual full range designs that do not require a cross-over filter. Another problem is that most transducers (woofers for low pass, midranges for band pass and tweeters for high pass) are voice coil activated (driven) and move in a piston-like fashion to generate their respective frequency ranges. This implies a difficult balancing act, by the transducer's designer, between cost, dynamic range, linearity, reliability, resolution and sound pressure level (SPL).

What this means is that there are a lot of fairly good loudspeaker designs available to consumers that are relatively economical. This also means that there is some fine resolution sonic information that is almost impossible to reproduce. This is undesirable, since we need to perceive this fine resolution sonic information in order to render our listening experience of the reproduced sounds credible in terms of sound staging cues, to perceive a more ‘real’ reproduction.

What would be welcomed to consumers is a way to get more of the required sonic information from a system that does not require rendering obsolete their existing equipment. Such a device would have to work with the existing audio data signals and ‘re-arrange’ the signal without ‘losing or adding anything’, thus allowing the loudspeakers to reproduce ‘more details’ so that a more coherent sound can be heard.

### SUMMARY OF THE INVENTION

It is thus an object of the invention to provide a system and apparatus for reproducing enhanced stereo sound which is respectful of the stereophonic information, i.e. does not introduce any false and/or synthesized signals, and which does not add any amplification in the signal so that it does not require a discrete power supply and thus does not diminish the performance of any given high-end sound system.

The system and method of the invention reintroduces sonic cues that are already in the signal after power amplification is done. It is a passive, real-time, post-amplification circuit.

The system and method of the present invention is also compatible with surround sound encoding such as Dolby's Surround™ and Pro-Logic™. When listening to such soundtracks over stereo loudspeakers with the teachings of the present invention, one will notice that the sound takes on a 3D and “seems like it is solid and right there”.

The present invention must accomplish its goal without deteriorating the integrity of the stereo sound information, nor with any overworking of the amplifier. The more stable in impedance, the better, particularly in the low frequency range where complex impedance loads can damage most amplifiers.

In accordance with the invention, these and other objects are achieved with an apparatus for decoding an enhanced stereo sound effect from a stereo signal comprising an input for receiving a stereo signal including localisation cues, said stereo signal comprising a left channel and a right channel, each of said left and right channels being carried over a pair of wires including a positive lead and a negative lead; means for outputting said positive leads of said right and left channels directly; and means for outputting said negative leads of said right and left channels, said means for outputting including a decoding circuit for decoding the localisation cues from said stereo signal.

The invention also concerns an apparatus comprising an input for receiving a stereo signal, said stereo signal including fundamentals and localisation cues; means for generating a differential signal from said stereo signal; means for generating a differentiated signal from said stereo signal; means for introducing said differential signal into said differentiated signal to create a combined signal; means for introducing said fundamentals into said combined signal to create a decoded signal; and means for outputting said decoded signal.

The invention also concerns a method for decoding an enhanced stereo sound effect from a stereo signal, comprising the steps of: receiving a stereo signal, said stereo signal including fundamentals and localisation cues; generating a differential signal from said stereo signal; generating a differentiated signal from said stereo signal; introducing said differential signal into said differentiated signal to create a combined signal; introducing said fundamentals into said combined signal to create a decoded signal; and outputting said decoded signal into a left channel and a right channel.

In a preferred embodiment of the invention, the basic stereo data is taken as a basis for the enhancements; a differential signal from an L-R simple circuit is generated, leaving a differentiated signal; the differential signal is introduced to the differentiated signal and the fundamentals of the signal are also introduced into the differentiated signal, order to maintain impedance and sonic integrity.

### BRIEF DESCRIPTION OF THE FIGURES

The present invention will be better understood after reading the following description of a preferred embodiment of a preferred embodiment thereof made with reference to the following figures in which:

FIG. 1 is a schematic representation of fundamentals and localisation cues;

FIG. 2 is a schematic representation of basic stereo information;

FIG. 3 is a schematic representation of enhanced stereo using the method and system of the present invention;

FIGS. 4A to 4G are schematic representations of the method of the present invention;

FIG. 5 is a schematic diagram of a circuit according to a preferred embodiment of the present invention;

FIG. 6 is a schematic diagram of a circuit according to a second preferred embodiment of the present invention;

FIG. 7 is a schematic diagram of a circuit according to a third preferred embodiment of the present invention; and

FIGS. 8a and 8b are schematic representations of the effect of the third preferred embodiment of the invention.

### DESCRIPTION OF PREFERRED EMBODIMENTS

As mentioned previously, the system and method of the invention will only reintroduce sonic cues that are already in the signal after power amplification is done. It is a passive, real-time, post-amplification circuit.

The present invention is also be compatible with surround sound encoding such as Dolby's Surround™ and Pro-Logic™. When listening to such soundtracks over stereo loudspeakers with the teachings of the present invention, one will notice that the sound take on a 3D and “seems like it is solid and right there”.

The present invention must accomplish its goal without deteriorating the integrity of the stereo sound information, nor with any overworking of the amplifier. The more stable in impedance, the better, particularly in the low frequency range where complex impedance loads can damage most amplifiers.

Essentially, as mentioned previously, the present invention takes the basic stereo data as the basis for the decoding and enhancements. From this basic stereo signal, which includes fundamental and localisation cues, a differential signal from an L-R simple circuit is generated, leaving a differentiated signal. The differential signal is introduced to the differentiated signal, and the fundamentals are introduced to the differentiated signal in order to maintain impedance and sonic integrity.

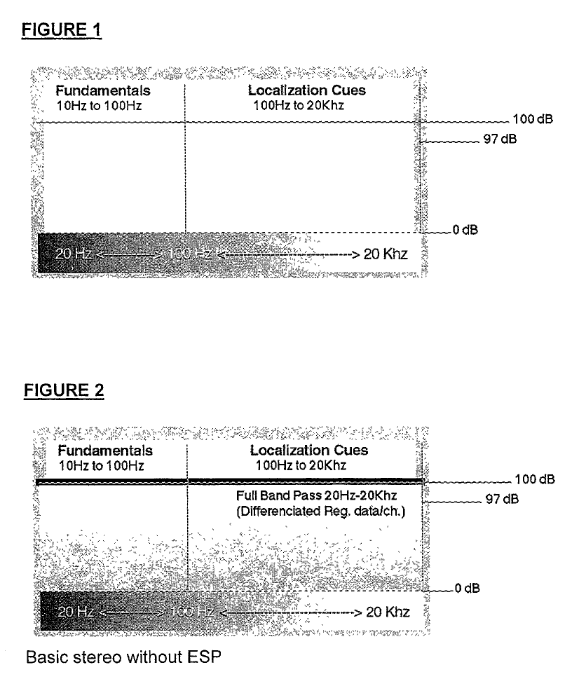

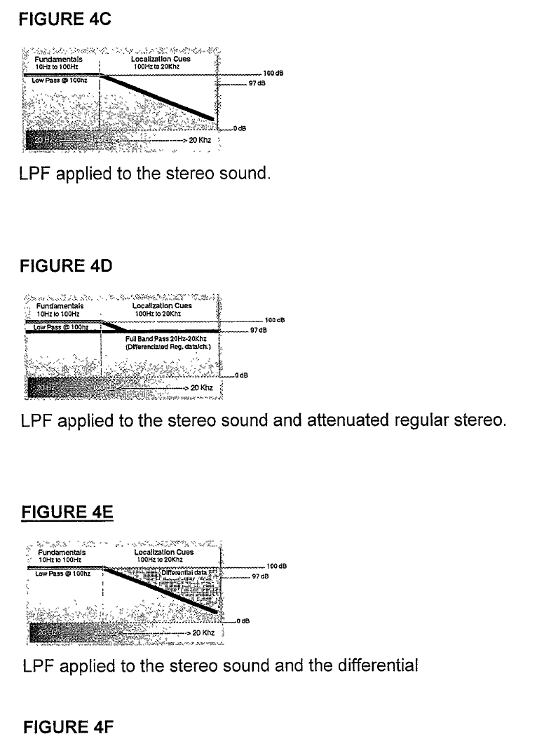

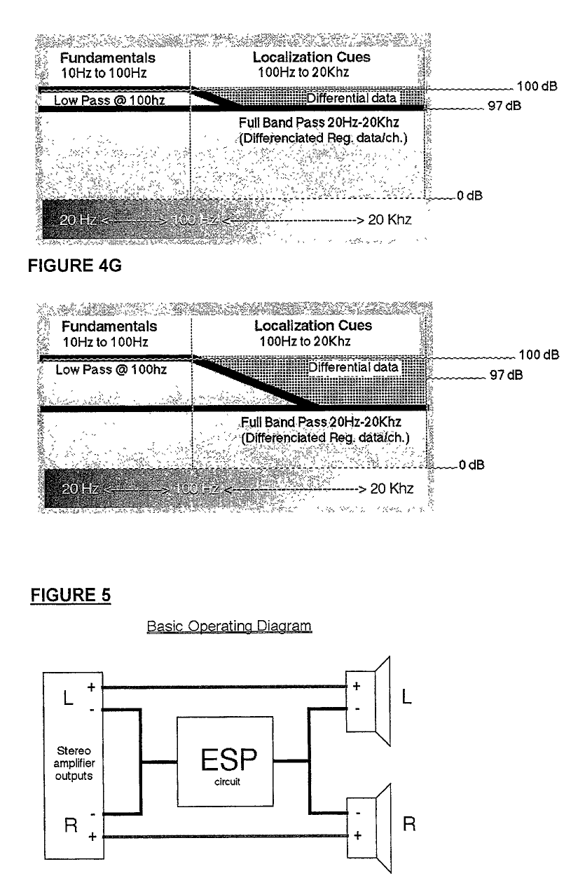

Referring now to FIGS. 4A-4G, the system and method of the present invention first takes the basic stereo data as a basis for the enhancements (illustrated in FIG. 2). A differential signal is generated (FIG. 4A) which leaves a differentiated signal. The differential signal is re-introduced (or simply introduced) into the differentiated signal (FIG. 4B). The fundamental cues are then re-introduced (or introduced) into the differentiated signal in order to maintain impedance and sonic integrity. In FIG. 4C, a LPF is applied to the stereo signal. In a preferred embodiment, the cut-off frequency is approximately 100 Hz, but other frequencies are acceptable. At 4D the LPF is applied to the stereo signal and attenuated regular stereo and at 4E, the LPF is applied to the stereo signal and the differential signal. The combination of the differential signal, the differentiated signal and the fundamentals is shown in FIG. 4F. Alternatively, if the circuit of the present invention forces more attenuation to the stereo signal, the result is shown in FIG. 4G.

The present invention works between both the stereo amplifier and both loudspeakers required to reproduce conventional stereo. In a preferred embodiment, the circuit is placed on the common negative return from both left (L) and right (R) loudspeakers (FIG. 5).

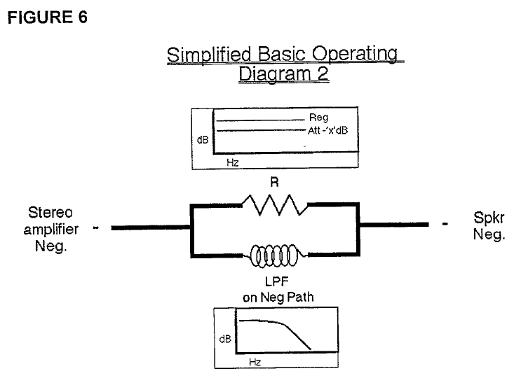

The circuit, in a preferred embodiment of the invention shown in FIG. 6, is preferably comprised of a low-pass filter (LPF), in parallel with a band-pass filter (BPF). As shown, resistor (R) is used as a BPF (not acting as a shunt circuit to the inductor coil filter). This reduces the amplitude of the full bandwidth signal feeding each loudspeakers as seen in the graph as the Att -‘x’ dB curve.

Also, the LPF will allow the low frequencies to bypass the resistor. This will in effect leave the fundamentals below a value determined by the L value untouched by the BPF that the R creates.

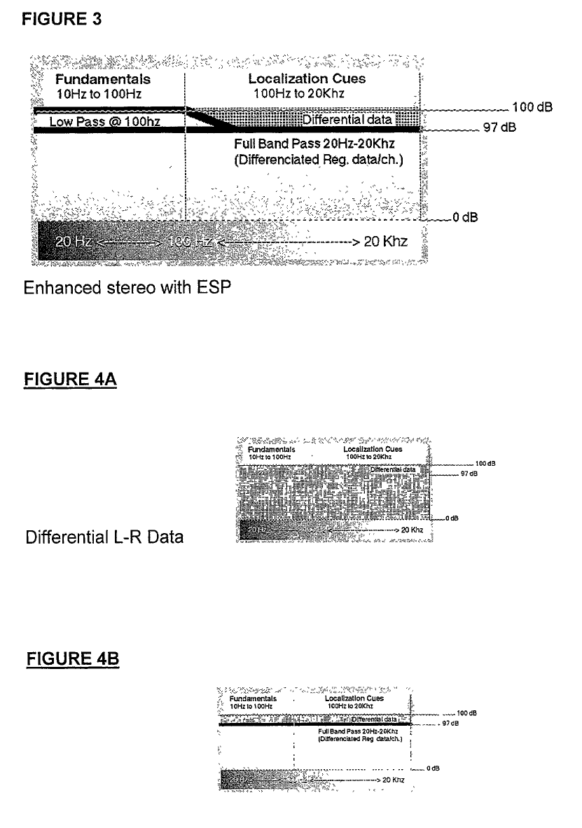

The present circuit begs the question “What about the remaining audio signal energy?” It is outputted in differential mode as can be seen in FIG. 3.

Notice that in this example we can observe a −3 dB level being applied to the Full Band Pass differentiated regular data per channel. This is the effect of the resistor.

Also notice the effect of the LPF for the fundamentals as well as the resulting differential (sonic) data.

The components values will vary depending on what is the targeted impedance load of the system in which the present invention will be used. For example, if the circuit of the present invention is to be used on a typical sound system with average loudspeakers that exhibit a Z-imp of 8 Ohms, the values for the L of the LPF and the R of the BPF will be different than if circuit was to be targeted to a post-headphone amplifier, since the impedance of headsets tend to have a more significant Ohm value (usually about 30 to 600 Ohms).

In application (as was tested with an actual prototype of the circuit), it has been found that there is not enough of a perceived difference in the effect created by the circuit of the present invention to justify modifying the components of the circuit of the present invention to drive loudspeakers that exhibit a nominal impedance of 4 to 8 Ohms. In other words, a simple circuit can work well with loudspeakers that exhibit a nominal impedance of 4 to 8 Ohms even if the LPF Fc (cut-off frequency) will vary a little bit, which is in theory not perfect. This is satisfactory provided the fundamentals below 100 Hz are as intact as possible.

Another benefit of the LPF in the circuit is that practically all stereophonic amplifiers that can be utilized to drive a pair of loudspeakers will not ‘see’ a complex impedance at low frequencies (below 100 Hz) and therefore will not go into an ‘unstable’ mode. (i.e. the amplifier does not ‘notice’ a significant change in loudspeaker impedance when the circuit is operating and will therefore not be damaged by the circuit. The potential differential data is allowed by the circuit to be dissipated by both the left and right loudspeakers.)

The following results have been obtained with the circuit of the present invention:

Stage and image—The circuit provided a “sharper,” more focused view into the stage. Sounds displayed much more stable and solid images both emanating from smaller, more concise points in space yet seeming larger in that space than before. On an even more exhilarating note, it widened the very rear of the stage, which most often tends to narrow as it retreats. This typical stage sort of loosely resembles a triangle, with its base between the speakers and its apex somewhere behind the back wall. It again contributed more focus and clarity to the newly widened rear of the stage. It noticeably extended the depth the soundstage on every recording auditioned. Its effect on the layering of individual instruments within the stage was anything but subtle. It imparted the stereo soundscape with a greater degree of the more rounded and three-dimensional layered presentation one normally comes to expect only from live sound. And with vinyl records, even more of this already good stuff due to the extra harmonic data that can be extracted from such a media was obtained.

Timbre—Voices—be they brass, bronze, gut, reed, human, et al.—were portrayed in a manner that is closer to sonic truth. They also seem a bit more liquid and vibrant. They were presented with more “breath,” sounding more like the voice of a real instrument played in space.

Dynamics—Transients were faster, both enriching the overall harmonics and adding another degree of deftness to the overall truthfulness of the presentation.

Focus and clarity—Details were more clearly emphasized. Subtle noises become recognizable sounds and were more readily apparent. Things that previously tended to be confused or masked down towards the noise floor possessed more detail. The entire rendering, front to back, left to right, and top to bottom, was brought into better focus, as if suddenly viewed through a sharper lens or as if a curtain of fog was lifted.

Bass—Well, that has varied widely, from no apparent change to a distinct addition of weight and resolution. But the bass seems considerably more recording specific than the other characteristics.

While this device may not afford the same degree of enhancement in every system, it will be apparent to an expert in the field that it will work with all stereophonic systems.

The circuit creates and plays with a ratio between the differentiated signals of a conventional stereophonic complementary signal (2 channels i.e. the left and right signals) and the potential differential data that can be found in such of a conventional stereophonic complementary signal, without altering the fundamentals of sound thanks to the LPF of the circuit.

This means that the fundamentals and the differential data combines and serves as a ‘canvas’ for the differentiated spatial localization cues of the conventional stereophonic complementary signal (2 channels i.e. the left and right signals) data.

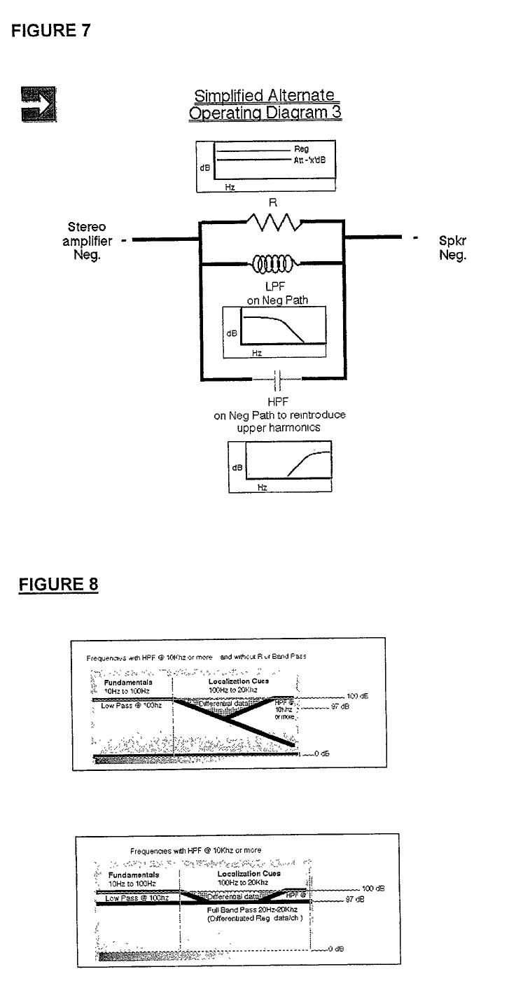

In a preferred embodiment of the invention, shown in FIG. 7, the system of the present invention is preferably located in the negative wires that carry the stereo signals, the positive wires being unaffected. Consequently, the circuit of FIG. 6 is the parallel connection of the resistor R and coil LPF which connects the negative wires.

An alternate versions of the circuit is shown in FIG. 7. One can reintroduce very high frequencies in the envelope of sound that the circuit processes. It has been found that frequencies above 10 Khz can be reintroduced by using a capacitor of appropriate value in parallel with the inductor and resistance (i.e. a high-pass filter (HPF)). This will allow the upper harmonics to be reproduced in differentiated pure stereophonic mode. It is not preferred to the basic circuit design since it offers the upper harmonics with more amplitude than the relative level of the total circuit bandwidth, yet it can be pleasing in effect with some recordings. Other frequencies for the HPF are also suitable.

The circuit of the present invention relates to the reproduction of enhanced stereo sound, and is more in particular directed to an improved alternative method and apparatus enabling the enhanced stereo sound effect to be decoded from a stereophonic signal after regular stereophonic amplification, increasing the compatibility with the end user's amplification sound system. The goal is to produce a spatialised 3D sound output from a set of loudspeakers, in a post amplification process.

The goal of the circuit is directed to the provision of a method and apparatus for the reproduction of enhanced stereo sound, wherein:

The enhancement of stereo sound is done in a post stereo amplification fashion thus allowing the end user to keep using his regular stereo sound system while being able to enhanced spatialized sound. and also control his listening experience.

The enhancement is compatible with all two channel mixed encoding standards.

The enhancement system does not require any additional power source.

The enhancement system offers a full bandwidth to stereo channels. (10 hz-22 Khz)

The enhancement is compatible with all regular consumer or professional loudspeakers.

The enhancement can be tailored to unusual & complex loudspeaker impedance loads.

The enhancement can also be tailored to specific application such as multi-media applications, automobile sound applications, virtual reality applications, etc . . .

The enhancement can also be integrated to different types of user interface (ex. for computing, auto-sound, home & professional applications, etc . . . )

The invention is thus directed to a method and apparatus for the decoding and reproduction enhanced stereo sound effect after amplification of the stereophonic encoded signals are amplified by the user's conventional stereophonic amplifiers. With the invention, the stereo and/or surround sound information is decoded from the amplified signal energy that is fed to the circuit from any conventional stereophonic amplifier. The invention works between the stereophonic amplifier and the two loudspeakers needed for proper stereophonic sound.

The circuit of the invention can be made to fit power requirements that vary from small powered systems (as in computers & portable sound systems) to very high power systems (as in professional sound systems).

Although the present invention has been described by way of preferred embodiments thereof, it should be understood the invention is not limited to these precise embodiments, and that various changes and modifications may be effected without departing from the scope or spirit of the invention.

1. An apparatus for decoding an enhanced stereo sound effect from a stereo signal, comprising:
(a) an input for receiving a stereo signal including localisation cues, said stereo signal comprising a left channel and a right channel, each of said left and right channels being carried over a pair of wires including a positive lead and a negative lead;
(b) means for outputting said positive leads of said right and left channels directly; and
(c) means for outputting said negative leads of said right and left channels, said means for outputting including a decoding circuit for decoding the localisation cues from said stereo signal.

2. An apparatus according to claim 1, wherein said decoding circuit is a LR circuit.

3. An apparatus according to claim 1, wherein said decoding circuit is comprised of a resistor, a low-pass filter and a high-pass filter, connected in parallel.

4. An apparatus according to claim 3, wherein said cut-off frequency of said low-pass filter is 100 Hz, and said cut-off frequency of said high-pass filter is 10 kHz.

5. An apparatus for decoding an enhanced stereo sound effect from a stereo signal, comprising:
(a) an input for receiving a stereo signal, said stereo signal including fundamentals and localisation cues;
(b) means for generating a differential signal from said stereo signal;
(c) means for generating a differentiated signal from said stereo signal;
(d) means for introducing said differential signal into said differentiated signal to create a combined signal;
(e) means for introducing said fundamentals into said combined signal to create a decoded signal; and
(f) means for outputting said decoded signal.

6. An apparatus according to claim 5, wherein said stereo signal is comprised of a left and a right channel, each channel being carried on a positive and a negative wire, and wherein said means for generating a differential signal, said means for generating a differentiated signal, said means for introducing said differential signal and said means for introducing said fundamentals include connecting said negative wires of said right and left channels together, and connecting in parallel therein a resistor and a coil.

7. A method for decoding an enhanced stereo sound effect from a stereo signal, comprising:
(a) receiving a stereo signal, said stereo signal including fundamentals and localisation cues;
(b) generating a differential signal from said stereo signal;
(c) generating a differentiated signal from said stereo signal;
(d) introducing said differential signal into said differentiated signal to create a combined signal;
(e) introducing said fundamentals into said combined signal to create a decoded signal; and
(f) outputting said decoded signal into a left channel and a right channel.
